(19) United States
(12) Patent Application Publication
(10) Pub. No.: US 2026/0251301 A1
(43) Pub. Date: Aug. 27, 2026

(54) PLANT AND METHOD FOR OPERATING PLANT

(71) Applicant: MITSUBISHI HEAVY INDUSTRIES, LTD., Tokyo (JP)

(72) Inventors: Rei IKEDA, Tokyo (JP); Satoko FUJII, Tokyo (JP); Masahiko NAKAHARA, Tokyo (JP); Takashi SHIRAIWA, Tokyo (JP); Takefumi TAKAHASHI, Tokyo (JP); Shinya UCHIDA, Tokyo (JP); Atsuhiko KANEBAKO, Tokyo (JP); Shinichi YAMAZAKI, Tokyo (JP); Mitsuhiro MORISHITA, Tokyo (JP)

(21) Appl. No.: 19/145,124

(22) PCT Filed: Jan. 24, 2024
(86) PCT No.: PCT/JP2024/002020

§ 371 Date: Jul. 1, 2025

(30) Foreign Application Priority Data
Jan. 31, 2023 (JP) 2023-012456

(51) Int. Cl. F23K 5/00; F17D 1/02; F23N 3/06; F23N 5/26

(52) U.S. Cl. CPC F23K 5/007; F17D 1/02; F23N 3/065; F23N 5/26; F23K 2400/201; F23N 2225/04; F23N 2235/18

(57) ABSTRACT

A plant including: second gas piping connected to first gas piping for guiding first combustible gas from a first supply source to a gas-using device; two gas cutoff valves positioned in the second gas piping; vent piping connected to a position on the second gas piping between the two gas cutoff valves; a vent valve positioned in the vent piping; and a pressure gauge that reports the pressure within vent pressure control piping in the vent piping. When the two gas cutoff valves are closed, the vent valve operates so that the pressure within the vent pressure control piping is less than the supply pressure of the first combustible gas supplied by the first supply source to the first gas piping and the supply pressure of a second combustible gas supplied by a second supply source to the second gas piping, and is greater than atmospheric pressure.

### TECHNICAL FIELD

The present invention relates to a plant including a pipe through which a combustible gas can flow and a method for operating a plant.

Priority is claimed on Japanese Patent Application No. 2023-012456 filed on Jan. 31, 2023, the content of which is incorporated herein by reference.

### BACKGROUND ART

As the plant including the pipe through which the combustible gas can flow, for example, there is a plant described in PTL 1 below.

This plant includes a combustible gas pipe, a first gas valve, a second gas valve, a nitrogen purge pipe, a nitrogen valve, a pressure regulating valve, a vent pipe, and a vent valve. The combustible gas pipe can supply the combustible gas from the combustible gas supply source to a heating furnace as a gas utilization device. The first gas valve is disposed in the combustible gas pipe. The second gas valve is disposed closer to a heating furnace side than the first gas valve in the combustible gas pipe is. The nitrogen purge pipe is connected at a position between the first gas valve and the second gas valve in the combustible gas pipe. The nitrogen purge pipe can supply high-pressure nitrogen from a high-pressure nitrogen supply source to a space between the first gas valve and the second gas valve in the combustible gas pipe. The nitrogen valve is disposed in the nitrogen purge pipe. The vent pipe has a first end and a second end. The first end of the vent pipe is connected to a position of the combustible gas pipe between the first gas valve and the second gas valve. The second end of the vent pipe is open to an atmosphere. The vent valve is disposed in the vent pipe.

In this plant, when the supply of the combustible gas to the heating furnace is not required, first, the first gas valve and the second gas valve are closed. Next, the vent valve and the nitrogen valve are opened, and the high-pressure nitrogen from the high-pressure nitrogen supply source is supplied between the first gas valve and the second gas valve in the combustible gas pipe through the nitrogen purge pipe. Some of the nitrogen is exhausted from the vent pipe. When the space between the first gas valve and the second gas valve in the combustible gas pipe is replaced with nitrogen from the combustible gas, the vent valve is closed. Then, the nitrogen valve is operated such that a pressure between the first gas valve and the second gas valve in the combustible gas pipe is maintained at a pressure higher than a pressure on the combustible gas supply source side of the first gas valve in the combustible gas pipe.

In this plant, each valve is controlled as described above, so that inflow of the combustible gas from the combustible gas supply source to the heating furnace can be reliably cut off. In addition, air can be prevented from flowing into the vent pipe and between the first gas valve and the second gas valve in the combustible gas pipe from the second end of the vent pipe. Therefore, in the combustible gas pipe, the mixing of the combustible gas and the air can be suppressed, and the safety of the plant can be improved.

### CITATION LIST

### Patent Literature

[PTL 1] Japanese Unexamined Patent Application Publication No. 61-029615

### SUMMARY OF INVENTION

### Technical Problem

In the plant described in PTL 1, in order to suppress the mixing of the combustible gas and the air and to enhance the safety of the plant, a high-pressure nitrogen supply source, a nitrogen purge pipe, and a nitrogen valve are required. Moreover, the nitrogen valve, a first purge pipe, the first gas valve, the second gas valve, the combustible gas pipe between the first gas valve and the second gas valve, and the vent valve need to have a high-pressure specification corresponding to the pressure of the high-pressure nitrogen. Further, the high-pressure rated shut-off valve increases the equipment cost. Further, in the plant described in PTL 1, high-pressure nitrogen is required when cutting off the inflow of the combustible gas from the combustible gas supply source to the heating furnace.

Accordingly, in the plant described in PTL 1, there is a problem in that the equipment cost and the operation cost increase.

Therefore, an object of the present disclosure is to provide a technique capable of reducing the equipment cost and the operation cost while suppressing the mixing of a combustible gas and air in a pipe to enhance safety of a plant.

### Solution to Problem

According to one aspect of the invention for achieving the above object, there is provided a plant including
a first gas pipe that is connected to a first supply source and a gas utilization device and that is configured to guide a first combustible gas from the first supply source to the gas utilization device; a second gas pipe that is connected to a second supply source and the first gas pipe and that is configured to guide a second combustible gas from the second supply source to the gas utilization device through the first gas pipe; a first gas shut-off valve that is disposed in the second gas pipe and that is configured to perform an opening and closing operation; a second gas shut-off valve that is disposed on a second supply source side with the first gas shut-off valve as a reference in the second gas pipe and that is configured to perform an opening and closing operation; a vent pipe that has a first end and a second end, in which the first end is connected to a position of the second gas pipe between the first gas shut-off valve and the second gas shut-off valve, and the second end is open to an atmosphere; a vent valve that is disposed in the vent pipe and that is configured to perform an opening and closing operation; and a pressure gauge that is configured to detect a pressure in a vent pressure control pipe, which is a pipe portion that includes a portion of the vent pipe on a second gas pipe side of the vent valve and a portion of the second gas pipe between the first gas shut-off valve and the second gas shut-off valve. When the first gas shut-off valve and the second gas shut-off valve are in a closed state, the vent valve is configured to operate such that a pressure in the vent pressure control pipe is lower than a first supply pressure, which is a supply pressure of the first combustible gas supplied to the first gas pipe by the first supply source, and a second supply pressure, which is a supply pressure of the second combustible gas supplied to the second gas pipe by the second supply source, and higher than an atmospheric pressure, according to the pressure in the vent pressure control pipe detected by the pressure gauge.

In the present aspect, when the first gas shut-off valve and the second gas shut-off valve are in the closed state, the vent valve is operated, and the pressure in the vent pressure control pipe is controlled to be lower than the first supply pressure and the second supply pressure and higher than the atmospheric pressure.

When the first gas shut-off valve and the second gas shut-off valve are in the closed state and the first supply source is in operation, the pressure of a downstream-side portion, which is a portion of the second gas pipe on the first gas pipe side of the first gas shut-off valve, is the first supply pressure. In addition, when the first gas shut-off valve and the second gas shut-off valve are in the closed state and the second supply source is in operation, the pressure of an upstream-side portion, which is a portion of the second gas pipe on a second supply source side of the second gas shut-off valve, is the second supply pressure.

Accordingly, there is a possibility that the first combustible gas in the downstream-side portion in the second gas pipe leaks from the first gas shut-off valve into the vent pressure control pipe having a pressure lower than that of the downstream-side portion. Even in a case where the first combustible gas leaks from the first gas shut-off valve into the vent pressure control pipe, the pressure in the vent pressure control pipe is lower than the pressure of the upstream-side portion in the second gas pipe. Therefore, there is no possibility that the first combustible gas flows into the upstream-side portion in the second gas pipe. In addition, there is a possibility that the second combustible gas in the upstream-side portion in the second gas pipe leaks from the second gas shut-off valve into the vent pressure control pipe having a pressure lower than that of the upstream-side portion. Even in a case where the second combustible gas leaks from the second gas shut-off valve into the vent pressure control pipe, the pressure in the vent pressure control pipe is lower than the pressure of the downstream-side portion in the second gas pipe. Therefore, there is no possibility that the second combustible gas flows into the downstream-side portion in the second gas pipe.

Therefore, in the present aspect, when the first gas shut-off valve and the second gas shut-off valve are in the closed state, the first combustible gas can be prevented from flowing into the upstream-side portion in the second gas pipe and being mixed with the second combustible gas in the upstream-side portion. In addition, in the present aspect, when the first gas shut-off valve and the second gas shut-off valve are in the closed state, the second combustible gas can be prevented from flowing into the downstream-side portion in the second gas pipe and being mixed with the first combustible gas in the downstream-side portion.

Further, in the present aspect, when the first gas shut-off valve and the second gas shut-off valve are in the closed state, the pressure in the vent pressure control pipe is higher than the atmospheric pressure. Therefore, the atmosphere can be prevented from flowing into the vent pressure control pipe and being mixed with the combustible gas in the vent pressure control pipe. Therefore, in the present aspect, the safety of the plant can be improved.

In addition, in the present aspect, in order to suppress the mixing of air into the pipe, the high-pressure nitrogen supply source, the nitrogen purge pipe, and the nitrogen valve included in the plant described in PTL 1 are not required. Therefore, in the present aspect, the equipment cost and the operation cost of the plant can be reduced.

A method for operating a plant as one aspect of the invention for achieving the above object is applied to the following plant.

The plant includes a first gas pipe that is connected to a first supply source and a gas utilization device and that is configured to guide a first combustible gas from the first supply source to the gas utilization device, a second gas pipe that is connected to a second supply source and the first gas pipe and that is configured to guide a second combustible gas from the second supply source to the gas utilization device through the first gas pipe, a first gas shut-off valve that is disposed in the second gas pipe and that is configured to perform an opening and closing operation, a second gas shut-off valve that is disposed on a second supply source side with the first gas shut-off valve as a reference in the second gas pipe and that is configured to perform an opening and closing operation, a vent pipe that has a first end and a second end, in which the first end is connected to a position of the second gas pipe between the first gas shut-off valve and the second gas shut-off valve, and the second end is open to an atmosphere, and a vent valve that is disposed in the vent pipe and that is configured to perform an opening and closing operation.

The method for operating a plant executes a pressure detection step of detecting a pressure in a vent pressure control pipe, which is a pipe portion that includes a portion of the vent pipe on a second gas pipe side of the vent valve and a portion of the second gas pipe between the first gas shut-off valve and the second gas shut-off valve; and a pressure control step of, when the first gas shut-off valve and the second gas shut-off valve are in a closed state, operating the vent valve such that a pressure in the vent pressure control pipe is lower than a first supply pressure, which is a supply pressure of the first combustible gas supplied to the first gas pipe by the first supply source, and a second supply pressure, which is a supply pressure of the second combustible gas supplied to the second gas pipe by the second supply source, and higher than an atmospheric pressure, according to the pressure in the vent pressure control pipe detected by the pressure gauge.

By executing the operating method of the present aspect, as in the plant in the above aspect, it is possible to reduce the equipment cost and the operation cost while suppressing the mixing of the combustible gas and the air in the pipe to enhance the safety of the plant.

### Advantageous Effects of Invention

According to one aspect of the present disclosure, it is possible to reduce the equipment cost and the operation cost while suppressing the mixing of the combustible gas and the air in the pipe to enhance the safety of the plant.

### Brief Description of Drawings

FIG. 1 is a system diagram of a plant in an embodiment according to the present disclosure.

FIG. 2 is a flowchart showing an operation of the plant in the embodiment of the present disclosure.

FIG. 3 is a time chart showing a pressure change in a vent pressure control pipe in the embodiment of the present disclosure,

### Description of Embodiments

Hereinafter, an embodiment of a plant according to the present disclosure will be described with reference to the drawings.

### Embodiment

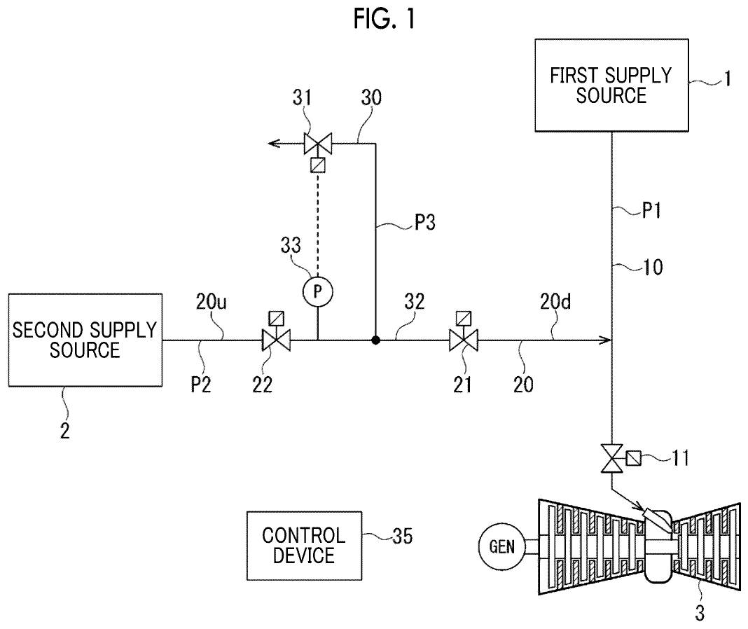

As shown in FIG. 1, the plant in the present embodiment includes a first gas pipe 10 through which a first combustible gas can flow, a flow regulation valve 11 disposed in the first gas pipe 10, a second gas pipe 20 through which a second combustible gas can flow, two gas shut-off valves 21 and 22 disposed in the second gas pipe 20, a vent pipe 30 connected to the second gas pipe 20, a vent valve 31 disposed in the vent pipe 30, a pressure gauge 33, and a control device 35.

The first gas pipe 10 has a first end and a second end. The first end of the first gas pipe 10 is connected to a first supply source 1, and the second end of the first gas pipe 10 is connected to a gas utilization device 3. Therefore, the first gas pipe 10 can guide the first combustible gas from the first supply source 1 to the gas utilization device 3. The flow regulation valve 11 disposed in the first gas pipe 10 can regulate a flow rate of the gas flowing in the first gas pipe 10.

The second gas pipe 20 has a first end and a second end. The first end of the second gas pipe 20 is connected to a second supply source 2, and the second end of the second gas pipe 20 is connected to a position of the first gas pipe 10 between the first supply source 1 and the flow regulation valve 11. Therefore, the second gas pipe 20 can guide the second combustible gas from the second supply source 2 to the gas utilization device 3 through the first gas pipe 10.

The two gas shut-off valves 21 and 22 are disposed in series in the second gas pipe 20. The gas shut-off valve on the first gas pipe 10 side among the two gas shut-off valves 21 and 22 forms the first gas shut-off valve 21. The gas shut-off valve on the second supply source 2 side among the two gas shut-off valves 21 and 22 forms the second gas shut-off valve 22.

The vent pipe 30 has a first end and a second end. The first end of the vent pipe 30 is connected to a position of the second gas pipe 20 between the two gas shut-off valves 21 and 22. The second end of the vent pipe 30 is open to an atmosphere. The in-pipe diameter of the vent pipe 30 is smaller than the in-pipe diameter of the second gas pipe 20. Accordingly, the size of the vent valve 31 disposed in the vent pipe 30 is also smaller than the sizes of the two gas shut-off valves 21 and 22 disposed in the second gas pipe 20.

The pressure gauge 33 is capable of detecting a pressure in the vent pressure control pipe 32. The vent pressure control pipe 32 is a pipe that includes a portion of the vent pipe 30 on the second gas pipe 20 side of the vent valve 31 and a portion of the second gas pipe 20 between the two gas shut-off valves 21 and 22. The vent valve 31 can perform an opening and closing operation according to the pressure detected by the pressure gauge 33.

The first gas shut-off valve 21, the second gas shut-off valve 22, the vent valve 31, and the flow regulation valve 11 described above all have a valve body and a controller.

The control device 35 controls the opening and closing of the first gas shut-off valve 21, the second gas shut-off valve 22, and the flow regulation valve 11 according to an instruction or the like from the outside.

The gas utilization device 3 is, for example, a gas turbine. The first combustible gas is, for example, natural gas. The second combustible gas is, for example, hydrogen.

A first supply pressure P1, which is the supply pressure of the first combustible gas supplied from the first supply source 1 to the first gas pipe 10, is, for example, 2.50 MPa. In addition, a second supply pressure P2, which is the supply pressure of the second combustible gas supplied from the second supply source 2 to the second gas pipe 20, is, for example, 2.75 MPa.

Next, the operation of the plant described above will be described.

In this plant, there are a first aspect and a second aspect as aspects when the gas utilization device 3 uses the combustible gas. According to the first aspect, there is provided an aspect in which the gas utilization device 3 uses only the first combustible gas from the first supply source 1. According to the second aspect, there is provided an aspect in which the gas utilization device 3 uses the first combustible gas from the first supply source 1 and the second combustible gas from the second supply source 2.

In the first aspect, the control device 35 instructs the first gas shut-off valve 21 and the second gas shut-off valve 22 to be closed. Therefore, in the first aspect, the first gas shut-off valve 21 and the second gas shut-off valve 22 are in a closed state. Further, in the first aspect, the control device 35 determines the flow rate of the first combustible gas used by the gas utilization device 3, and instructs the flow regulation valve 11 to set the valve opening degree corresponding to the flow rate. Therefore, in the first aspect, only the first combustible gas is supplied from the first supply source 1 to the gas utilization device 3 at a predetermined flow rate.

In the second aspect, the control device 35 instructs the first gas shut-off valve 21 and the second gas shut-off valve 22 to open, and instructs the vent valve 31 to close. Accordingly, in the second aspect, the first gas shut-off valve 21 and the second gas shut-off valve 22 are in an open state, and the vent valve 31 is in a closed state. Further, in the second aspect, the control device 35 determines the flow rate of the mixed gas of the first combustible gas and the second combustible gas used by the gas utilization device 3, and instructs the flow regulation valve 11 to set the valve opening degree corresponding to the flow rate. Therefore, in the second aspect, the mixed gas of the first combustible gas from the first supply source 1 and the second combustible gas from the second supply source 2 is supplied to the gas utilization device 3 at a predetermined flow rate.

In an aspect in which the gas utilization device 3 does not use the combustible gas, the control device 35 instructs the first gas shut-off valve 21, the second gas shut-off valve 22, and the flow regulation valve 11 to close. Therefore, at this time, the first combustible gas from the first supply source 1 and the second combustible gas from the second supply source 2 are not supplied to the gas utilization device 3.

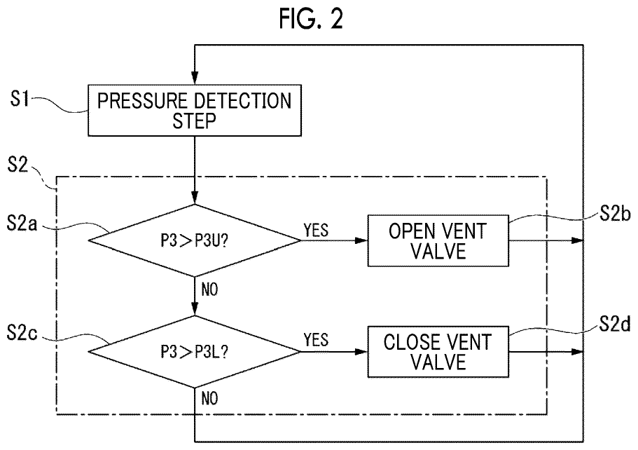

In the first aspect described above and in the aspect in which the gas utilization device 3 does not use the combustible gas, the first gas shut-off valve 21 and the second gas shut-off valve 22 are in a closed state. The plant in a state where the first gas shut-off valve 21 and the second gas shut-off valve 22 are closed will be described with reference to the flowchart shown in FIG. 2.

When the first gas shut-off valve 21 and the second gas shut-off valve 22 are in the closed state, a pressure detection step S1 and a pressure control step S2 are repeatedly performed.

In the pressure detection step S1, the pressure in the vent pressure control pipe 32 is detected by the pressure gauge 33.

In the pressure control step S2, the vent valve 31 is operated according to the pressure in the vent pressure control pipe 32 detected by the pressure gauge 33, and the pressure in the vent pressure control pipe 32 is controlled. In this control, the pressure in the vent pressure control pipe 32 is controlled to be lower than the first supply pressure P1 and the second supply pressure P2 and higher than an atmospheric pressure Pa.

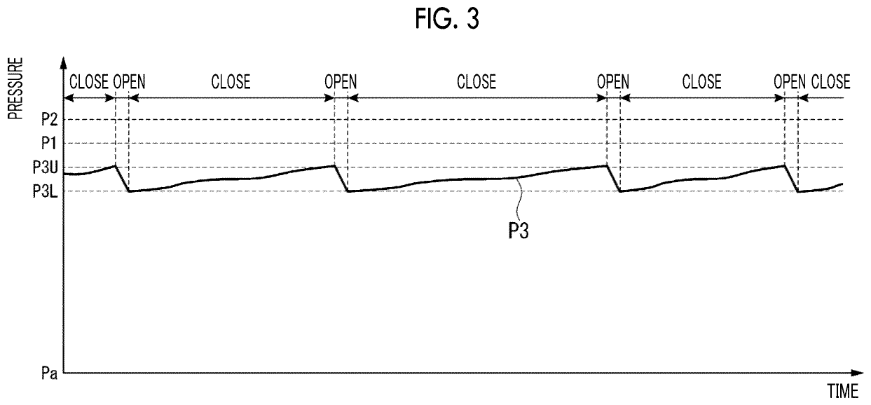

An upper limit value P3U and a lower limit value P3L are set in advance in the controller of the vent valve 31. As shown in FIG. 3, the upper limit value P3U is a pressure value lower than the first supply pressure PI (for example, 2.50 MPa) and the second supply pressure P2 (for example, 2.75 MPa) and higher than the atmospheric pressure Pa. The upper limit value P3U is, for example, 2.30 MPa. The lower limit value P3L is a pressure value higher than the atmospheric pressure Pa and lower than the upper limit value P3U described above. The lower limit value P3L is, for example, 2.00 MPa. In addition, the controller of the vent valve 31 recognizes that the first gas shut-off valve 21 and the second gas shut-off valve 22 are in the closed state through a notification from the control device 35.

Specifically, in the pressure control step S2, the controller of the vent valve 31 determines whether or not a pressure P3 in the vent pressure control pipe 32 detected by the pressure gauge 33 is higher than a predetermined lower limit value P3L (S2a). When the controller of the vent valve 31 determines that the pressure P3 in the vent pressure control pipe 32 detected by the pressure gauge 33 is higher than the upper limit value P3U, the valve body of the vent valve 31 is brought into an open state (S2b). That is, the vent valve 31 is in the open state. When the vent valve 31 is in the open state, the process returns to the pressure detection step S1 again.

When the controller of the vent valve 31 determines that the pressure P3 in the vent pressure control pipe 32 detected by the pressure gauge 33 is not higher than the lower limit value P3L, the controller determines whether or not the pressure P3 is lower than the predetermined lower limit value P3L (S2c). When the controller of the vent valve 31 determines that the pressure P3 in the vent pressure control pipe 32 detected by the pressure gauge 33 is lower than the lower limit value P3L, the valve body of the vent valve 31 is brought into a closed state (S2d). That is, the vent valve 31 is in the closed state. When the vent valve 31 is in the closed state, the process returns to the pressure detection step S1 again.

When the controller of the vent valve 31 determines that the pressure P3 in the vent pressure control pipe 32 detected by the pressure gauge 33 is not higher than the upper limit value P3U and not lower than the lower limit value P3L, that is, the pressure P3 is a value between the upper limit value P3U and the lower limit value P3L, the process returns to the pressure detection step S1 again.

When the vent valve 31 operates as described above in a state where the first gas shut-off valve 21 and the second gas shut-off valve 22 are in the closed state, the pressure P3 in the vent pressure control pipe 32 changes as shown in FIG. 3.

When the pressure P3 in the vent pressure control pipe 32 exceeds the upper limit value P3U, the vent valve 31 is opened as described above. Accordingly, the gas in the vent pressure control pipe 32 is released to the atmosphere via the vent valve 31. As a result, the pressure P3 in the vent pressure control pipe 32 is lowered. When the pressure P3 in the vent pressure control pipe 32 falls below the lower limit value P3L, the vent valve 31 is closed as described above. The first combustible gas leaking from the first gas shut-off valve 21 or the second combustible gas leaking from the second gas shut-off valve 22 may flow into the vent pressure control pipe 32. Accordingly, the pressure P3 in the vent pressure control pipe 32 may gradually increase. Then, the pressure P3 in the vent pressure control pipe 32 may exceed the upper limit value P3U again. In this case as well, as described above, the vent valve 31 is opened, and the pressure P3 in the vent pressure control pipe 32 is lowered.

Thereafter, the pressure P3 in the vent pressure control pipe 32 fluctuates between a pressure value slightly above the lower limit value P3L and a pressure value slightly below the lower limit value P3L by opening and closing the vent valve 31. Therefore, when the first gas shut-off valve 21 and the second gas shut-off valve 22 are in the closed state, the vent valve 31 performs an intermittent opening operation, and the pressure P3 in the vent pressure control pipe 32 is controlled to be lower than the first supply pressure Pl and the second supply pressure P2 and higher than the atmospheric pressure Pa, as described above.

When the first gas shut-off valve 21 and the second gas shut-off valve 22 are in the closed state and the first supply source 1 is in operation, the pressure of a downstream-side portion 20d, which is a portion of the second gas pipe 20 on the first gas pipe 10 side of the first gas shut-off valve 21, is the first supply pressure P1. In addition, when the first gas shut-off valve 21 and the second gas shut-off valve 22 are in the closed state and the second supply source 2 is in operation, the pressure of an upstream-side portion 20u, which is a portion of the second gas pipe 20 on the second supply source 2 side of the second gas shut-off valve 22, is the second supply pressure P2.

Accordingly, there is a possibility that the first combustible gas in the downstream-side portion 20d in the second gas pipe 20 leaks from the first gas shut-off valve 21 into the vent pressure control pipe 32 having a pressure lower than that of the downstream-side portion 20d. Even in a case where the first combustible gas leaks from the first gas shut-off valve 21 into the vent pressure control pipe 32, the pressure P3 in the vent pressure control pipe 32 is lower than the pressure of the upstream-side portion 20u in the second gas pipe 20. Therefore, there is no possibility that the first combustible gas flows into the upstream-side portion 20u in the second gas pipe 20. In addition, there is a possibility that the second combustible gas in the upstream-side portion 20u in the second gas pipe 20 leaks from the second gas shut-off valve 22 into the vent pressure control pipe 32 having a pressure lower than that of the upstream-side portion 20u. Even in a case where the second combustible gas leaks from the second gas shut-off valve 22 into the vent pressure control pipe 32, the pressure P3 in the vent pressure control pipe 32 is lower than the pressure of the downstream-side portion 20d in the second gas pipe 20. Therefore, there is no possibility that the second combustible gas flows into the downstream-side portion 20d in the second gas pipe 20.

Therefore, in the present embodiment, when the first gas shut-off valve 21 and the second gas shut-off valve 22 are in the closed state, the first combustible gas can be prevented from flowing into the upstream-side portion 20u in the second gas pipe 20 and being mixed with the second combustible gas in the upstream-side portion 20u. In addition, in the present embodiment, when the first gas shut-off valve 21 and the second gas shut-off valve 22 are in the closed state, the second combustible gas can be prevented from flowing into the downstream-side portion 20d in the second gas pipe 20 and being mixed with the first combustible gas in the downstream-side portion 20d.

Further, in the present embodiment, when the first gas shut-off valve 21 and the second gas shut-off valve 22 are in the closed state, the pressure in the vent pressure control pipe 32 is higher than the atmospheric pressure Pa. Therefore, the atmosphere can be prevented from flowing into the vent pressure control pipe 32 and being mixed with the combustible gas in the vent pressure control pipe 32. Therefore, in the present embodiment, the safety of the plant can be improved.

In addition, in the present embodiment, the opening operation of the vent valve 31 is intermittent, and the release of the gas into the atmosphere through the vent pipe 30 is also intermittent. Accordingly, in the present aspect, unlike the operation in which the vent valve 31 is kept in a slightly open state for a long time, the gas and air mixture generated at an outlet of the vent pipe 30 does not remain for a long time. Therefore, the safety of the plant can be improved from this viewpoint as well.

In addition, in the present embodiment, in order to suppress the mixing of air into the pipe, the high-pressure nitrogen supply source, the nitrogen purge pipe, and the nitrogen valve included in the plant described in PTL 1 are not required. Therefore, in the present embodiment, the equipment cost and the operation cost of the plant can be reduced.

The plant in the present embodiment may also include the nitrogen supply source, the nitrogen purge pipe, and the nitrogen valve, which are included in the plant described in PTL 1. Even in this case, the pressure of the nitrogen from the nitrogen supply source is lower than the first supply pressure P1 and the second supply pressure P2. Therefore, the operation cost of the plant can be reduced. In addition, since the specifications of the nitrogen purge pipe and the nitrogen valve can be made to correspond to a lower pressure than the specifications of the nitrogen purge pipe and the nitrogen valve included in the plant described in PTL 1, the equipment cost of the plant can also be reduced.

In the present embodiment, when the first gas shut-off valve 21 and the second gas shut-off valve 22 are in the closed state, and the pressure P3 in the vent pressure control pipe 32 reaches the lower limit value P3L (for example, 2.00 MPa), which is a pressure value higher than the average pressure (1.75 MPa) between the first supply pressure P1 (for example, 2.50 MPa), which is the lower supply pressure of the first supply pressure PI (for example, 2.50 MPa) and the second supply pressure P2 (for example, 2.75 MPa), and the atmospheric pressure Pa, the vent valve 31 performs a closing operation. Therefore, in the present embodiment, when the first gas shut-off valve 21 and the second gas shut-off valve 22 are in the closed state, a pressure difference between the pressure of the downstream-side portion 20d in the second gas pipe 20 and the pressure in the vent pressure control pipe 32 is reduced. Therefore, in the present aspect, the amount of the first combustible gas present in the downstream-side portion 20d in the second gas pipe 20 leaking from the first gas shut-off valve 21 into the vent pressure control pipe 32 can be reduced. In addition, in the present embodiment, a pressure difference between the pressure of the upstream-side portion 20u of the second gas pipe 20 and the pressure in the vent pressure control pipe 32 is reduced. Accordingly, in the present embodiment, the amount of the second combustible gas present in the upstream-side portion 20u in the second gas pipe 20 leaking from the second gas shut-off valve 22 into the vent pressure control pipe 32 can be reduced. That is, in the present embodiment, the amount of the combustible gas leaking from each of the gas shut-off valves 21 and 22 into the vent pressure control pipe 32 can be reduced. As a result, in the present embodiment, the combustible gas can be suppressed from being unnecessarily released to the atmosphere via the vent valve 31.

In the present embodiment, since the in-pipe diameter of the vent pipe 30 is smaller than the in-pipe diameter of the second gas pipe 20, the size of the vent valve 31 disposed in the vent pipe 30 is smaller than the size of each of the gas shut-off valves 21 and 22 disposed in the second gas pipe 20. Therefore, in the present embodiment, the amount of the combustible gas in the vent pressure control pipe 32 leaking from the vent valve 31 to the atmosphere can be reduced. As a result, in the present embodiment, the combustible gas can be suppressed from being unnecessarily released to the atmosphere via the vent valve 31.

### Modification Example

In the above description, the first aspect and the second aspect have been exemplified as the aspects in which the gas utilization device 3 uses the gas. However, as an aspect in which the gas utilization device 3 uses the gas, a third aspect may be provided. The third aspect is an aspect in which the gas utilization device 3 only uses the second combustible gas from the second supply source 2. In this case, the shut-off valve is provided on the first supply source 1 side of a connection position with the second gas pipe 20 in the first gas pipe 10. Then, the shut-off valve and the vent valve 31 in the first gas pipe 10 are closed, and the first shut-off valve and the second gas shut-off valve 22 are opened to realize the third aspect.

In the above-described embodiment, the upper limit value P3U and the lower limit value P3L based on the first supply pressure Pl and the second supply pressure P2 are set in advance in the controller of the vent valve 31 on the premise that the first supply pressure P1 and the second supply pressure P2 are substantially constant. However, in a case where the first supply pressure Pl and the second supply pressure P2 fluctuate, it is preferable to provide a first pressure gauge that detects the first supply pressure P1 and a second pressure gauge that detects the second supply pressure P2. In this case, the control device 35 receives the first supply pressure P1 from the first pressure gauge and the second supply pressure P2 from the second pressure gauge, determines the upper limit value P3U and the lower limit value P3L based on these pressures, and sends the determined upper limit value P3U and lower limit value P3L to the controller of the vent valve 31.

In the above-described embodiment, the controller of the vent valve 31 receives the pressure P3 detected by the pressure gauge 33, and controls the opening and closing of the valve body of the vent valve 31 based on the pressure P3. However, the control device 35 may receive the pressure P3 detected by the pressure gauge 33 and control the opening and closing of the vent valve 31 based on the pressure P3.

The plant in the above-described embodiment may include the gas utilization device 3. In addition, the gas utilization device 3 does not need to be a gas turbine as long as the device uses two types of combustible gases. Therefore, the first combustible gas does not need to be natural gas, and the second combustible gas does not need to be hydrogen.

In addition, the present disclosure is not limited to each of the embodiments described above. Various additions, modifications, substitutions, partial deletions, and the like can be made without departing from the conceptual idea and gist of the present invention derived from the contents defined in the claims and equivalents thereof.

### Supplementary Notes

The plant in the above-described embodiment and modification example is understood as follows, for example.
(1) A plant in a first aspect includes a first gas pipe 10 that is connected to a first supply source 1 and a gas utilization device 3 and that is configured to guide a first combustible gas from the first supply source 1 to the gas utilization device 3; a second gas pipe 20 that is connected to a second supply source 2 and the first gas pipe 10 and that is configured to guide a second combustible gas from the second supply source 2 to the gas utilization device 3 through the first gas pipe 10; a first gas shut-off valve 21 that is disposed in the second gas pipe 20 and that is configured to perform an opening and closing operation; a second gas shut-off valve 22 that is disposed on a second supply source 2 side with the first gas shut-off valve 21 as a reference in the second gas pipe 20 and that is configured to perform an opening and closing operation; a vent pipe 30 that has a first end and a second end, in which the first end is connected to a position of the second gas pipe 20 between the first gas shut-off valve 21 and the second gas shut-off valve 22, and the second end is open to an atmosphere; a vent valve 31 that is disposed in the vent pipe 30 and that is configured to perform an opening and closing operation; and a pressure gauge 33 that is configured to detect a pressure in a vent pressure control pipe 32, which is a pipe portion that includes a portion of the vent pipe 30 on a second gas pipe 20 side of the vent valve 31 and a portion of the second gas pipe 20 between the first gas shut-off valve 21 and the second gas shut-off valve 22.

When the first gas shut-off valve 21 and the second gas shut-off valve 22 are in a closed state, the vent valve 31 is configured to operate such that a pressure in the vent pressure control pipe 32 is lower than a first supply pressure P1, which is a supply pressure of the first combustible gas supplied to the first gas pipe 10 by the first supply source 1, and a second supply pressure P2, which is a supply pressure of the second combustible gas supplied to the second gas pipe 20 by the second supply source 2, and higher than an atmospheric pressure Pa, according to the pressure in the vent pressure control pipe 32 detected by the pressure gauge 33.

In the present aspect, when the first gas shut-off valve 21 and the second gas shut-off valve 22 are in the closed state, the vent valve 31 is operated, and the pressure P3 in the vent pressure control pipe 32 is controlled to be lower than the first supply pressure P1 and the second supply pressure P2 and higher than the atmospheric pressure Pa.

When the first gas shut-off valve 21 and the second gas shut-off valve 22 are in the closed state and the first supply source 1 is in operation, the pressure of a downstream-side portion 20d, which is a portion of the second gas pipe 20 on the first gas pipe 10 side of the first gas shut-off valve 21, is the first supply pressure P1. In addition, when the first gas shut-off valve 21 and the second gas shut-off valve 22 are in the closed state and the second supply source 2 is in operation, the pressure of an upstream-side portion 20u, which is a portion of the second gas pipe 20 on the second supply source 2 side of the second gas shut-off valve 22, is the second supply pressure P2.

Accordingly, there is a possibility that the first combustible gas in the downstream-side portion 20d in the second gas pipe 20 leaks from the first gas shut-off valve 21 into the vent pressure control pipe 32 having a pressure lower than that of the downstream-side portion 20d. Even in a case where the first combustible gas leaks from the first gas shut-off valve 21 into the vent pressure control pipe 32, the pressure P3 in the vent pressure control pipe 32 is lower than the pressure of the upstream-side portion 20u in the second gas pipe 20. Therefore, there is no possibility that the first combustible gas flows into the upstream-side portion 20u in the second gas pipe 20. In addition, there is a possibility that the second combustible gas in the upstream-side portion 20u in the second gas pipe 20 leaks from the second gas shut-off valve 22 into the vent pressure control pipe 32 having a pressure lower than that of the upstream-side portion 20u. Even in a case where the second combustible gas leaks from the second gas shut-off valve 22 into the vent pressure control pipe 32, the pressure P3 in the vent pressure control pipe 32 is lower than the pressure of the downstream-side portion 20d in the second gas pipe 20. Therefore, there is no possibility that the second combustible gas flows into the downstream-side portion 20d in the second gas pipe 20.

Therefore, in the present aspect, when the first gas shut-off valve 21 and the second gas shut-off valve 22 are in the closed state, the first combustible gas can be prevented from flowing into the upstream-side portion 20u in the second gas pipe 20 and being mixed with the second combustible gas in the upstream-side portion 20u. In addition, in the present aspect, when the first gas shut-off valve 21 and the second gas shut-off valve 22 are in the closed state, the second combustible gas can be prevented from flowing into the downstream-side portion 20d in the second gas pipe 20 and being mixed with the first combustible gas in the downstream-side portion 20d.

Further, in the present aspect, when the first gas shut-off valve 21 and the second gas shut-off valve 22 are in the closed state, the pressure in the vent pressure control pipe 32 is higher than the atmospheric pressure Pa. Therefore, the atmosphere can be prevented from flowing into the vent pressure control pipe 32 and being mixed with the combustible gas in the vent pressure control pipe 32. Therefore, in the present aspect, the safety of the plant can be improved.

In addition, in the present aspect, in order to suppress the mixing of air into the pipe, the high-pressure nitrogen supply source, the nitrogen purge pipe, and the nitrogen valve included in the plant described in PTL 1 are not required. Therefore, in the present aspect, the equipment cost and the operation cost of the plant can be reduced.
(2) A second aspect provides the plant according to the first aspect, in which, when the first gas shut-off valve 21 and the second gas shut-off valve 22 are in the closed state, the vent valve 31 is configured to operate such that a pressure in the vent pressure control pipe 32 becomes higher than an average pressure of a supply pressure, which is the lower of the first supply pressure Pl and the second supply pressure P2, and the atmospheric pressure Pa.

Therefore, in the present aspect, when the first gas shut-off valve 21 and the second gas shut-off valve 22 are in the closed state, a pressure difference between the pressure of the downstream-side portion 20d, which is a portion of the second gas pipe 20 on the first gas pipe 10 side of the first gas shut-off valve 21, and the pressure in the vent pressure control pipe 32 is reduced. Therefore, in the present aspect, the amount of the first combustible gas present in the downstream-side portion 20d in the second gas pipe 20 leaking from the first gas shut-off valve 21 into the vent pressure control pipe 32 can be reduced. In addition, in the present aspect, a pressure difference between the pressure of the upstream-side portion 20u, which is a portion of the second gas pipe 20 on the second supply source 2 side of the second gas shut-off valve 22, and the pressure in the vent pressure control pipe 32 is reduced. Accordingly, in the present aspect, the amount of the second combustible gas present in the upstream-side portion 20u in the second gas pipe 20 leaking from the second gas shut-off valve 22 into the vent pressure control pipe 32 can be reduced. That is, in the present aspect, the amount of the combustible gas leaking from each of the gas shut-off valves 21 and 22 into the vent pressure control pipe 32 can be reduced. As a result, in the present aspect, the combustible gas can be suppressed from being unnecessarily released to the atmosphere via the vent valve 31.
(3) A third aspect provides the plant according to the first aspect or the second aspect, in which the vent valve 31 is configured to perform an opening operation at an upper limit value P3U which is a pressure value lower than the first supply pressure P1 and the second supply pressure P2 and higher than the atmospheric pressure Pa, and to perform a closing operation at a lower limit value P3L which is a pressure value lower than the upper limit value P3U and higher than the atmospheric pressure Pa.

In the present aspect, the opening operation of the vent valve 31 is intermittent, and the release of the gas into the atmosphere through the vent pipe 30 is also intermittent. Accordingly, in the present aspect, unlike the operation in which the vent valve 31 is kept in a slightly open state for a long time, the gas and air mixture generated at an outlet of the vent pipe 30 does not remain for a long time. Therefore, the safety of the plant can be improved.
(4) A fourth aspect provides the plant according to any one of the first aspect to the third aspect, in which an in-pipe diameter of the vent pipe 30 is smaller than an in-pipe diameter of the second gas pipe 20.

In the present aspect, since the in-pipe diameter of the vent pipe 30 is smaller than the in-pipe diameter of the second gas pipe 20, the size of the vent valve 31 disposed in the vent pipe 30 is smaller than the sizes of the first gas shut-off valve 21 and the second gas shut-off valve 22 disposed in the second gas pipe 20. Therefore, in the present aspect, the amount of the combustible gas in the vent pressure control pipe 32 leaking from the vent valve 31 to the atmosphere can be reduced. As a result, in the present aspect, the combustible gas can be suppressed from being unnecessarily released to the atmosphere via the vent valve 31.
(5) A fifth aspect provides the plant according to any one of the first aspect to the fourth aspect, the plant further including a gas turbine as the gas utilization device 3.

The method for operating a plant in the above-described embodiment and modification example is understood as follows, for example.
(6) A method for operating a plant in a sixth aspect is applied to the following plant.

The plant includes a first gas pipe 10 that is connected to a first supply source 1 and a gas utilization device 3 and that is configured to guide a first combustible gas from the first supply source 1 to the gas utilization device 3, a second gas pipe 20 that is connected to a second supply source 2 and the first gas pipe 10 and that is configured to guide a second combustible gas from the second supply source 2 to the gas utilization device 3 through the first gas pipe 10, a first gas shut-off valve 21 that is disposed in the second gas pipe 20 and that is configured to perform an opening and closing operation, a second gas shut-off valve 22 that is disposed on a second supply source 2 side with the first gas shut-off valve 21 as a reference in the second gas pipe 20 and that is configured to perform an opening and closing operation, a vent pipe 30 that has a first end and a second end, in which the first end is connected to a position of the second gas pipe 20 between the first gas shut-off valve 21 and the second gas shut-off valve 22, and the second end is open to an atmosphere, and a vent valve 31 that is disposed in the vent pipe 30 and that is configured to perform an opening and closing operation.

The method for operating a plant executes a pressure detection step S1 of detecting a pressure in a vent pressure control pipe 32, which is a pipe portion that includes a portion of the vent pipe 30 on a second gas pipe 20 side of the vent valve 31 and a portion of the second gas pipe 20 between the first gas shut-off valve 21 and the second gas shut-off valve 22; and a pressure control step S2 of, when the first gas shut-off valve 21 and the second gas shut-off valve 22 are in a closed state, operating the vent valve 31 such that a pressure in the vent pressure control pipe 32 is lower than a first supply pressure P1, which is a supply pressure of the first combustible gas supplied to the first gas pipe 10 by the first supply source 1, and a second supply pressure P2, which is a supply pressure of the second combustible gas supplied to the second gas pipe 20 by the second supply source 2, and higher than an atmospheric pressure Pa, according to the pressure in the vent pressure control pipe 32 detected in the pressure detection step S1.

By executing the operating method of the present aspect, as in the plant in the first aspect, it is possible to reduce the equipment cost and the operation cost while suppressing the mixing of the combustible gas and the air in the pipe to enhance the safety of the plant.
(7) A seventh aspect provides the method for operating a plant according to the sixth aspect, in which in the pressure control step S2, the vent valve 31 is operated such that the pressure in the vent pressure control pipe 32 becomes higher than an average pressure of a supply pressure, which is the lower of the first supply pressure P1 and the second supply pressure P2, and the atmospheric pressure Pa.

By executing the operating method of the present aspect, as in the plant in the second aspect, the combustible gas can be suppressed from being unnecessarily released to the atmosphere.
(8) An eighth aspect provides the method for operating a plant according to the sixth aspect or the seventh aspect, in which in the pressure control step S2, the vent valve 31 performs an opening operation at an upper limit value P3U which is a pressure value lower than the first supply pressure P1 and the second supply pressure P2 and higher than the atmospheric pressure Pa, and performs a closing operation at a lower limit value P3L which is a pressure value lower than the upper limit value P3U and higher than the atmospheric pressure Pa.

By executing the operating method of the present aspect, as in the plant in the third aspect, the opening operation of the vent valve 31 is intermittent, and the safety of the plant can be improved.
(9) A ninth aspect provides the method for operating a plant according to any one of the sixth aspect to the eighth aspect, in which the second combustible gas has hydrogen gas as a main component.

### INDUSTRIAL APPLICABILITY

According to one aspect of the present disclosure, it is possible to reduce the equipment cost and the operation cost while suppressing the mixing of the combustible gas and the air in the pipe to enhance the safety of the plant.

### REFERENCE SIGNS LIST

1: first supply source
2: second supply source
3: gas utilization device
10: first gas pipe
11: flow regulation valve
20: second gas pipe
20d: downstream-side portion
20u: upstream-side portion
21: first gas shut-off valve
22: second gas shut-off valve
30: vent pipe
31: vent valve
32: vent pressure control pipe
33: pressure gauge
35: control device
P1: first supply pressure
P2: second supply pressure
P3: pressure in vent pressure control pipe
P3L: lower limit value
P3U: upper limit value
Pa: atmospheric pressure

1. A plant comprising:
a first gas pipe that is connected to a first supply source and a gas utilization device and that is configured to guide a first combustible gas from the first supply source to the gas utilization device;
a second gas pipe that is connected to a second supply source and the first gas pipe and that is configured to guide a second combustible gas from the second supply source to the gas utilization device through the first gas pipe;
a first gas shut-off valve that is disposed in the second gas pipe and that is configured to perform an opening and closing operation;
a second gas shut-off valve that is disposed on a second supply source side with the first gas shut-off valve as a reference in the second gas pipe and that is configured to perform an opening and closing operation;
a vent pipe that has a first end and a second end, in which the first end is connected to a position of the second gas pipe between the first gas shut-off valve and the second gas shut-off valve, and the second end is open to an atmosphere;
a vent valve that is disposed in the vent pipe and that is configured to perform an opening and closing operation; and
a pressure gauge that is configured to detect a pressure in a vent pressure control pipe, which is a pipe portion that includes a portion of the vent pipe on a second gas pipe side of the vent valve and a portion of the second gas pipe between the first gas shut-off valve and the second gas shut-off valve,
wherein, when the first gas shut-off valve and the second gas shut-off valve are in a closed state, the vent valve is configured to operate such that a pressure in the vent pressure control pipe is lower than a first supply pressure, which is a supply pressure of the first combustible gas supplied to the first gas pipe by the first supply source, and a second supply pressure, which is a supply pressure of the second combustible gas supplied to the second gas pipe by the second supply source, and higher than an atmospheric pressure, according to the pressure in the vent pressure control pipe detected by the pressure gauge.

2. The plant according to claim 1,
wherein, when the first gas shut-off valve and the second gas shut-off valve are in the closed state, the vent valve is configured to operate such that a pressure in the vent pressure control pipe becomes higher than an average pressure of a supply pressure, which is the lower of the first supply pressure and the second supply pressure, and the atmospheric pressure.

3. The plant according to claim 1,
wherein the vent valve is configured to perform an opening operation at an upper limit value which is a pressure value lower than the first supply pressure and the second supply pressure and higher than the atmospheric pressure, and to perform a closing operation at a lower limit value which is a pressure value lower than the upper limit value and higher than the atmospheric pressure.

4. The plant according to claim 1,
wherein an in-pipe diameter of the vent pipe is smaller than an in-pipe diameter of the second gas pipe.

5. The plant according to claim 1, further comprising:
a gas turbine as the gas utilization device.

6. A method for operating a plant including
a first gas pipe that is connected to a first supply source and a gas utilization device and that is configured to guide a first combustible gas from the first supply source to the gas utilization device,
a second gas pipe that is connected to a second supply source and the first gas pipe and that is configured to guide a second combustible gas from the second supply source to the gas utilization device through the first gas pipe,
a first gas shut-off valve that is disposed in the second gas pipe and that is configured to perform an opening and closing operation,
a second gas shut-off valve that is disposed on a second supply source side with the first gas shut-off valve as a reference in the second gas pipe and that is configured to perform an opening and closing operation,
a vent pipe that has a first end and a second end, in which the first end is connected to a position of the second gas pipe between the first gas shut-off valve and the second gas shut-off valve, and the second end is open to an atmosphere, and
a vent valve that is disposed in the vent pipe and that is configured to perform an opening and closing operation, the method comprising:
a pressure detection step of detecting a pressure in a vent pressure control pipe, which is a pipe portion that includes a portion of the vent pipe on a second gas pipe side of the vent valve and a portion of the second gas pipe between the first gas shut-off valve and the second gas shut-off valve; and
a pressure control step of, when the first gas shut-off valve and the second gas shut-off valve are in a closed state, operating the vent valve such that a pressure in the vent pressure control pipe is lower than a first supply pressure, which is a supply pressure of the first combustible gas supplied to the first gas pipe by the first supply source, and a second supply pressure, which is a supply pressure of the second combustible gas supplied to the second gas pipe by the second supply source, and higher than an atmospheric pressure, according to the pressure in the vent pressure control pipe detected in the pressure detection step.

7. The method for operating a plant according to claim 6,
wherein in the pressure control step, the vent valve is operated such that the pressure in the vent pressure control pipe becomes higher than an average pressure of a supply pressure, which is the lower of the first supply pressure and the second supply pressure, and the atmospheric pressure.

8. The method for operating a plant according to claim 6,
wherein in the pressure control step, the vent valve performs an opening operation at an upper limit value which is a pressure value lower than the first supply pressure and the second supply pressure and higher than the atmospheric pressure, and performs a closing operation at a lower limit value which is a pressure value lower than the upper limit value and higher than the atmospheric pressure.

9. The method for operating a plant according to claim 6,
wherein the second combustible gas has hydrogen gas as a main component.
